(19) United States
(12) Patent Application Publication
(10) Pub. No.: US 2024/0280979 A1
(43) Pub. Date: Aug. 22, 2024

(54) ABNORMALITY PROCESSING APPARATUS, NETWORK SYSTEM, AND METHOD FOR PROVIDING PROCEDURE WITH RESPECT TO ABNORMALITY HAVING OCCURRED IN ROBOT SYSTEM

(71) Applicant: Fanuc Corporation, Minamitsuru-gun, Yamanashi (JP)

(72) Inventor: Shinji Kurihara, Minamitsuru-gun, Yamanashi (JP)

(73) Assignee: Fanuc Corporation, Minamitsuru-gun, Yamanashi (JP)

(21) Appl. No.: 18/567,149

(22) PCT Filed: Jun. 21, 2021
(86) PCT No.: PCT/JP2021/023453

§ 371 Date: Dec. 5, 2023

(51) Int. Cl. G05B 23/02

(52) U.S. Cl. CPC G05B 23/0218

(57) ABSTRACT

An abnormality processing apparatus includes: a storage unit that stores a plurality of procedures for dealing with a plurality of types of abnormalities, in association with abnormality identification information for identifying the abnormalities; an abnormality detection unit that detects an abnormality based on motion state data of a robot system; a data acquiring unit that acquires abnormality identification information of the abnormality detected by the abnormality detection unit; and a procedure acquiring unit that acquires, from the plurality of procedures stored in the storage unit, a procedure corresponding to the abnormality identification information acquired by the data acquiring unit.

### CROSS REFERENCE TO RELATED APPLICATIONS

This is the U.S. National Phase application of PCT/JP2021/023453, field Jun. 21, 2021, the disclosures of this application being incorporated herein by reference in its entirety for all purposes.

### FIELD OF THE INVENTION

The present disclosure relates to an abnormality processing device, a network system, and a method of providing a procedure for an abnormality which occurs in a robot system.

### BACKGROUND OF THE INVENTION

A known device displays a work procedure to be performed by an operator at a work line when an abnormality has occurred in a robot system (e.g., Patent Document 1).

### PATENT LITERATURE

[PTL 1] JP 2014-223694 A

### SUMMARY OF THE INVENTION

In a robot system, various abnormalities such as malfunction of a robot and abnormal detection values of various sensors provided at the robot may occur. In the related art, there is a demand for a technique that can appropriately deal with such various abnormalities.

An abnormality processing device that provides a procedure for dealing with an abnormality which occurs in a robot system includes a storage that stores a plurality of the procedures for dealing with a plurality of types of the abnormalities respectively in association with abnormality specifying information for specifying the abnormalities; an abnormality detecting unit that detects the abnormality, based on operation condition data of the robot system; a data acquiring unit that acquires the abnormality specifying information on the abnormality detected by the abnormality detecting unit; and a procedure acquiring unit that acquires the procedure corresponding to the abnormality specifying information acquired by the data acquiring unit, from among the plurality of procedures stored in the storage.

A method of providing a procedure for an abnormality which occurs in a robot system includes storing, in a storage, a plurality of the procedures for dealing with a plurality of types of the abnormalities respectively in association with abnormality specifying information for specifying the abnormalities; detecting the abnormality based on operation condition data of the robot system; acquiring the abnormality specifying information on the detected abnormality; and acquiring the procedure corresponding to the acquired abnormality specifying information, from among the plurality of procedures stored in the storage.

According to the present disclosure, it is possible to automatically acquire and provide procedures for dealing with various abnormalities that may occur in a robot system. Thus, it is possible to appropriately and easily deal with various abnormalities.

### BRIEF DESCRIPTION OF DRAWINGS

FIG. 1 is a block diagram of a network system according to an embodiment.

FIG. 2 is an example of a robot system illustrated in FIG. 1.

FIG. 3 is a block diagram of a network system according to another embodiment.

FIG. 4 is a flowchart illustrating an example of a method of providing a procedure for an abnormality in the robot system.

FIG. 5 is a flowchart illustrating another example of the method of providing a procedure for an abnormality in the robot system.

FIG. 6 is a block diagram of a network system according to still another embodiment.

### DETAILED DESCRIPTION OF EMBODIMENTS OF THE INVENTION

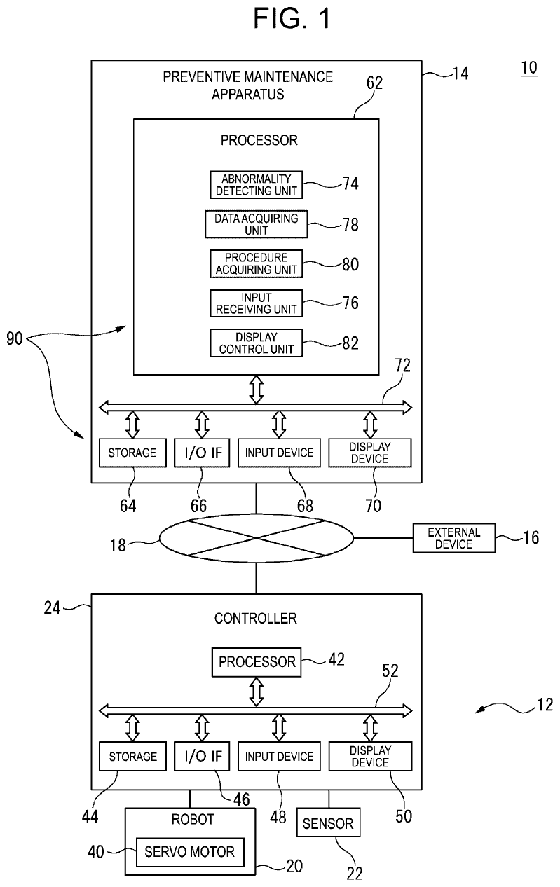

Embodiments of the present disclosure will be described in detail below based on the drawings. Note that in the various embodiments described below, similar elements are denoted by the same signs, and overlapping descriptions thereof will be omitted. First, a network system 10 according to an embodiment will be described with reference to FIG. 1. The network system 10 includes a robot system 12, a preventive maintenance device 14, an external device 16, and a communication network 18.

The robot system 12 is an industrial robot system that performs predetermined work on a workpiece. The preventive maintenance device 14 acquires, from the robot system 12, operation condition data OD indicating an operation condition of the robot system 12 and monitors an abnormality AB in the robot system based on the operation condition data OD.

The external device 16 is a computer such as a desktop or portable PC or a server. The communication network 18 is, for example, a LAN (such as an intranet) or the Internet and communicably connects the robot system 12, the preventive maintenance device 14, and the external device 16 to each other. As an example, the robot system 12 can be installed in a first building in which a work line is provided, the preventive maintenance device 14 can be installed in a second building different from the first building, and the external device 16 can be installed in a third building different from the first building and the second building.

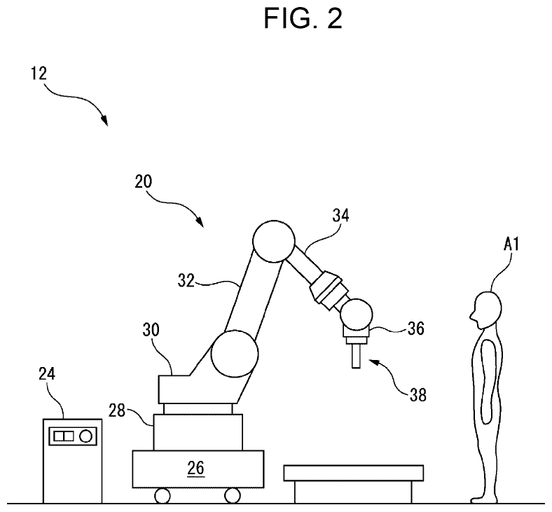

FIG. 2 illustrates an example of the robot system 12. The robot system 12 includes a robot 20, a sensor 22 (FIG. 1), and a controller 24. In the example illustrated in FIG. 2, the robot 20 is a vertical articulated robot and includes a guided vehicle 26, a robot base 28, a rotating torso 30, a lower arm 32, an upper arm 34, a wrist 36, and an end effector 38. The guided vehicle 26 may be, for example, an automated guided vehicle (AGV) self-driven in response to a command from the controller 24 or a manual guided vehicle manually moved by an operator A1. The robot 20 can be moved to a given position by the guided vehicle 26.

The robot base 28 is fixed on the guided vehicle 26. The rotating torso 30 is provided at the robot base 28 so as to be pivotable about a vertical axis. The lower arm 32 is provided at the rotating torso 30 so as to be rotatable about a horizontal axis, and the upper arm 34 is rotatably provided at a distal end portion of the lower arm 32.

The wrist 36 is provided at a distal end portion of the upper arm 34 so as to be rotatable about two axes orthogonal to each other. The end effector 38 is removably attached to a distal end portion (so-called wrist flange) of the wrist 36. The end effector 38 is, for example, a robot hand, a cutting tool, a welding torch, or the like, and performs predetermined work (workpiece handling, cutting, welding, or the like) on a workpiece. Note that the robot hand may include a plurality of fingers grasping the workpiece or may include a suction pad sucking and holding the workpiece by generating a negative pressure between the suction pad and the workpiece.

A servo motor 40 (FIG. 1) is provided at each of the components (the guided vehicle 26, the robot base 28, the rotating torso 30, the lower arm 32, the upper arm 34, and the wrist 36) of the robot 20. The servo motor 40 drives each of the movable components (the guided vehicle 26, the rotating torso 30, the lower arm 32, the upper arm 34, and the wrist 36) of the robot 20 in response to a command from the controller 24.

The sensor 22 detects the operation condition data OD. Examples of the operation condition data OD may include a rotational position Pm, a rotation speed Vm, a rotation acceleration am, a current value I, and a load torque t of the servo motor 40. In this case, the sensor 22 may include a rotation detecting sensor 22A (such as an encoder or a Hall device) that detects a rotational position of the servo motor 40, a current sensor 22B that detects a current value of the servo motor 40, and a torque sensor 22C that detects a load torque of the servo motor 40.

The operation condition data OD may also include a position Pc, a speed Vc, and an acceleration ac of a movable component (e.g., the end effector 38) of the robot 20. The position Pc, the speed Vc, and the acceleration ac of the movable component (the end effector 38) of the robot 20 can be acquired from, for example, a detection value (specifically, the rotational position Pm) of the rotation detecting sensor 22A.

When the end effector 38 is a robot hand including a plurality of fingers, the operation condition data OD may include a pressure P of a cylinder that opens and closes the plurality of fingers. When the end effector 38 is a robot hand including a suction pad, the operation condition data OD may include a pressure P generated in the suction pad. In these cases, the sensor 22 may include a pressure sensor 22D that detects the pressure P.

The operation condition data OD may also include a voltage E of a battery for operating the controller 24 or the rotation detecting sensor 22A. In this case, the sensor 22 may include a voltage sensor 22E that detects the voltage E. The operation condition data OD may also include an external force F applied to the robot 20. In this case, the sensor 22 may include a force sensor 22F that detects the external force F.

In addition, the sensor 22 may include a vision sensor 22G arranged at a known position with respect to the robot 20, and the vision sensor 22G may capture image data ID of the workpiece as the operation condition data OD and supply the image data ID to the controller 24. In this case, the vision sensor 22G may provide the controller 24 with determination information for determining whether or not the image data ID of the workpiece has been appropriately captured, together with the image data ID.

In this way, the sensor 22 includes at least one of the sensors 22A, 22B, 22C, 22D, 22E, and 22F and detects at least one piece of the operation condition data OD (the rotational position Pm, the rotation speed Vm, the rotation acceleration am, the current value I, the load torque t, the position Pc, the speed Vc, the acceleration ac, the pressure P, the voltage E, the external force F, and the image data ID). Note that the operation condition data OD is not limited to the above-described examples and may include any other type of data, and the sensor 22 may be configured to detect such data.

The controller 24 is installed outside the robot 20 (or inside the guided vehicle 26) and controls an operation of the robot 20. As illustrated in FIG. 1, the controller 24 is a computer including a processor 42, a storage 44, an I/O interface 46, an input device 48, a display device 50, and the like. The processor 42 includes a CPU, a GPU, or the like, and is communicably connected to the storage 44, the I/O interface 46, the input device 48, and the display device 50 via a bus 52.

The storage 44 includes a RAM, a ROM, or the like, and temporarily or permanently stores various types of data used in arithmetic processing executed by the processor 42 and various types of data generated during the arithmetic processing. The I/O interface 46 includes, for example, an Ethernet (registered trademark) port, a USB port, an optical fiber connector, or an HDMI (registered trademark) terminal, and communicates data with the external device in a wired or wireless manner under a command from the processor 42. In the present embodiment, the I/O interface 46 is connected to the communication network 18, the sensor 22, and the servo motor 40.

The input device 48 includes a keyboard, a mouse, a touch panel, or the like and receives an input of data from an operator. The display device 50 includes a liquid crystal display, an organic EL display, or the like and displays various types of data. The input device 48 and the display device 50 may be provided as separate elements from a housing of the controller 24 or may be integrally incorporated in the housing of the controller 24.

The processor 42 acquires, from the sensor 22, the operation condition data OD (the rotational position Pm, the rotation speed Vm, the rotation acceleration am, the current value I, the load torque t, the position Pc, the speed Vc, the acceleration ac, the pressure P, the voltage E, the external force F, the image data ID, and the like) and continuously (e.g., periodically) transmits the acquired operation condition data OD to the preventive maintenance device 14 via the communication network 18.

The preventive maintenance device 14 is a computer including a processor 62, a storage 64, an I/O interface 66, an input device 68, a display device 70, and the like. Note that the configurations of the processor 62, the storage 64, the I/O interface 66, the input device 68, and the display device 70 are the same as those of the processor 42, the storage 44, the I/O interface 46, the input device 48, and the display device 50 described above, and thus overlapping descriptions thereof will be omitted.

The processor 62 is communicably connected to the storage 64, the I/O interface 66, the input device 68, and the display device 70 via a bus 72. The I/O interface 66 is connected to the communication network 18, and the processor 62 acquires the operation condition data OD from the controller 24 through the communication network 18 and stores the operation condition data OD in the storage 64.

The processor 62 detects the abnormality AB of the robot system 12 based on the acquired operation condition data OD. As an example, the processor 62 determines whether or not the operation condition data OD is different from a predetermined reference. Specifically, the processor 62 determines whether or not the value of the operation condition data OD (the rotational position Pm, the rotation speed Vm, the rotation acceleration am, the current value I, the load torque t, the position Pc, the speed Vc, the acceleration ac, the pressure P, or the voltage E) acquired from the sensor 22 exceeds a predetermined reference value β (OD>β or OD<β) and determines that the operation condition data OD is different from the reference when the value of the operation condition data OD exceeds the reference value β.

For example, when the end effector 38 is a robot hand including a suction pad, it can be determined whether or not the end effector 38 appropriately grasps the workpiece with the suction pad by monitoring the pressure P acquired from the pressure sensor 22D. When the pressure P increases beyond the reference value β_{P} (P>β_{P}) or decreases below the reference value β_{P} (P<β_{P}), the processor 62 can detect that an abnormality AB1 indicating grasping failure has occurred at the end effector 38. When the voltage E acquired from the voltage sensor 22E decreases below the reference value β_{E} (E<β_{E}), the processor 62 can detect that an abnormality AB2 indicating voltage drop has occurred at the battery of the controller 24 or the rotation detecting sensor 22A.

Moreover, when the external force F acquired from the force sensor 22F exceeds the reference value β_{F1} (F<β_{F1} or F>β_{F1}), the processor 62 can detect an abnormality AB3 indicating malfunction (i.e., failure) of the force sensor 22F or an abnormality AB4 indicating collision of the robot 20 with a surrounding environmental object (or the operator A1).

When acquiring the image data ID captured by the vision sensor 22G as the operation condition data OD, the processor 62 may determine, with reference to the determination information included in the image data ID, that the operation condition data OD (image data ID) is different from the reference when the determination information indicates that the image data ID has not been appropriately captured. As a result, the processor 62 can detect that an abnormality AB5 indicating imaging failure has occurred in the vision sensor 22G.

Alternatively, when the determination information is not included in the image data ID, the processor 62 may determine whether or not the image data ID is different from the reference based on the image data ID. Specifically, the controller 24 of the robot system 12 causes the vision sensor 22G to image a marker provided at a known position with respect to the robot 20 while the robot 20 performs work.

The processor 62 acquires the image data ID of the imaged marker from the robot system 12 and acquires the position of the marker in the image data ID. When the position of the marker deviates from a predetermined reference point, it may be determined that the image data ID is different from the reference. In this way, the processor 62 can detect, based on the image data ID, that the abnormality AB5 indicating imaging failure has occurred in the vision sensor 22G.

As another example, the processor 62 may detect the abnormality AB of the robot system 12 using a learning model LM constructed through machine learning. The learning model LM indicates a correlation between the operation condition data OD (e.g., the pressure P) and the abnormality AB in the robot system 12 (e.g., the abnormality AB1 indicating grasping failure at the end effector 38). For example, the learning model LM can be constructed by repeatedly providing a machine learning device with a learning data set DS1 including the operation condition data OD and determination data indicating the presence or absence of the abnormality AB (e.g., supervised learning).

The processor 62 sequentially inputs, to the learning model LM, the operation condition data OD continuously acquired from the robot system 12. When there is an abnormality AB having a high correlation with a change in the operation condition data OD input in a predetermined period, the learning model LM specifies and outputs the abnormality AB.

In this way, the processor 62 can detect the abnormality AB in the robot system 12 based on the operation condition data OD and the learning model LM. By using the learning model LM, the processor 62 can predict that a component (e.g., the servo motor 40 or the sensor 22) of the robot system 12 will fail due to the abnormality AB. Note that the processor 62 may be configured to execute the function of the above-described machine learning device.

As described above, in the present embodiment, the processor 62 functions as an abnormality detecting unit 74 (FIG. 1) that detects the abnormality AB based on the operation condition data OD. Here, in the present embodiment, the storage 64 stores a plurality of procedures PR for dealing with a plurality of types of the abnormalities AB respectively that may occur in the robot system 12 in association with abnormality specifying information SI for specifying the abnormalities AB.

As an example, the abnormality specifying information SI include abnormality identification codes SI1 individually assigned to the plurality of types of abnormalities AB (e.g., the abnormalities AB1, AB2, AB3, AB4, . . . ). Specifically, the abnormality identification codes SI1 are composed of a plurality of character strings (so-called error codes) and uniquely assigned to the plurality of types of abnormalities AB.

For example, the abnormality identification code SI1 with a character string of “AB001” is assigned to the abnormality AB1 indicating grasping failure of the end effector 38, the abnormality identification code SI1 with a character string of “AB002” is assigned to the abnormality AB2 indicating voltage drop of the battery, the abnormality identification code SI1 with a character string of “AB003” is assigned to the abnormality AB3 indicating malfunction of the force sensor 22F, the abnormality identification code SI1 with a character string of “AB004” is assigned to the abnormality AB4 indicating collision between the robot 20 and the surrounding environmental object, and the abnormality identification code SI1 with a character string of “AB005” is assigned to the abnormality AB5 indicating imaging failure of the vision sensor 22G.

On the other hand, the procedures PR for dealing with the various types of abnormalities AB are prepared in advance for the respective abnormalities AB. For example, each procedure PR includes image data of text for describing the procedure PR with words, or still or moving image data representing an operation in which the operator A1 performs the procedure PR, and the procedure in which the operator A1 deals with the abnormality AB is described with text, still images, or moving images. For example, a procedure PR1 for dealing with the abnormality AB1 indicating grasping failure of the end effector 38 including a suction pad includes image data for describing a procedure for checking the suction pad or an air valve that generates a negative pressure at the suction pad.

A procedure PR2 for dealing with the abnormality AB2 indicating voltage drop of the battery includes image data for describing a procedure for replacing the battery. A procedure PR4 for dealing with the abnormality AB4 indicating collision of the robot 20 with the surrounding environmental object includes image data for describing a procedure for checking the presence or absence of the collision. A procedure PR5 for dealing with the abnormality AB5 indicating imaging failure of the vision sensor 22G includes image data for describing a procedure for checking the installation position of the vision sensor 22G, checking a member (e.g., a lens) of the vision sensor 22G, and performing calibration of the vision sensor 22G.

The storage 64 stores the procedures PR (e.g., the procedures PR1, PR2, . . . ) and the abnormality specifying information SI (e.g., the abnormality identification codes SI1 of “AB001”, “AB002”, “AB003”, . . . ) in association with each other. An operator A2 of the preventive maintenance device 14 (e.g., a designer of the work line) operates the input device 68 to input the plurality of procedures PR (such as the procedure PR1) and the abnormality specifying information SI (such as the abnormality identification code SI1 of “AB001”) associated with the procedures PR.

The processor 62 receives an input of the procedures PR and the abnormality specifying information SI through the input device 68. Consequently, in the present embodiment, the processor 62 functions as an input receiving unit 76 (FIG. 1) that receives the input of the procedures PR and the abnormality specifying information SI. The storage 64 stores the procedures PR and the abnormality specifying information SI received by the processor 62 in association with each other. In this way, the procedures PR and the abnormality specifying information SI (specifically, the abnormality identification codes SI1) are stored in the storage 64 in advance.

When functioning as the abnormality detecting unit 74 to detect the abnormality AB, the processor 62 acquires the abnormality specifying information SI for specifying the abnormality AB. As an example, the storage 64 further stores a data table DT1 in which the type of the abnormality AB (e.g., the abnormality AB1 indicating grasping failure) and the abnormality identification code SI1 (e.g., “AB001”) assigned to the abnormality AB are stored in association with each other. The processor 62 acquires the abnormality identification code SI1 assigned to the detected abnormality AB as the abnormality specifying information SI with reference to the data table DT1.

As another example, the processor 62 may specify the abnormality AB based on the operation condition data OD by using the above-described learning model LM and also acquire the abnormality identification code SI1 assigned to the abnormality AB. The learning model LM in this case can be constructed by repeatedly providing the machine learning device with a learning data set DS2 including the operation condition data OD, the determination data indicating the presence or absence of the abnormality AB, and the abnormality identification code SI1 assigned to the abnormality AB.

The processor 62 sequentially inputs the operation condition data OD acquired from the robot system 12 to the learning model LM, and the learning model LM outputs, together with the specified abnormality AB, the abnormality identification code SI1 assigned to the abnormality AB. In this way, the processor 62 can acquire the abnormality AB in the robot system 12 and the abnormality identification code SI1 from the operation condition data OD. Thus, in the present embodiment, the processor 62 functions as a data acquiring unit 78 (FIG. 1) that acquires the abnormality specifying information SI (specifically, the abnormality identification code SI1) of the detected abnormality AB.

Next, the processor 62 acquires the procedure PR corresponding to the acquired abnormality specifying information SI from among the plurality of procedures PR stored in the storage 64. For example, when detecting the abnormality AB1 indicating grasping failure and acquiring, as the abnormality specifying information SI, the abnormality identification code SI1 of “AB001” assigned to the abnormality AB1, the processor 62 searches for and acquires the image data of the procedure PR1 associated with the abnormality identification code SI1 of “AB001” from among the plurality of procedures PRn (n=1, 2, 3, . . . ) stored in the storage 64. Thus, in the present embodiment, the processor 62 functions as a procedure acquiring unit 80 (FIG. 1) that acquires the procedure PR corresponding to the acquired abnormality specifying information SI.

The processor 62 then supplies the image data of the acquired procedure PR to the display device 70 through the bus 72 and causes the display device 70 to display the procedure PR as an image. The processor 62 transmits the image data of the acquired procedure PR to the communication network 18 through the I/O interface 66 and supplies the image data to the controller 24 via the communication network. The processor 42 of the controller 24 acquires the image data of the procedure PR via the I/O interface 46 and displays the procedure PR as an image on the display device 50.

In this way, in the present embodiment, the processor 62 functions as a display control unit 82 (FIG. 1) that causes the display devices 50 and 70 to display the acquired procedure PR as an image. Note that the processor 62 may function as the display control unit 82 to cause a display device (not illustrated) provided at the work line, instead of (or in addition to) the display device 50, to display the acquired procedure PR.

As described above, in the present embodiment, the storage 64 stores the plurality of procedures PR in association with the abnormality specifying information SI, and the processor 42 functions as the abnormality detecting unit 74, the input receiving unit 76, the data acquiring unit 78, the procedure acquiring unit 80, and the display control unit 82 to provide the procedure PR for dealing with the abnormality AB in the robot system 12.

Thus, the storage 64 and the processor 42 (the abnormality detecting unit 74, the input receiving unit 76, the data acquiring unit 78, the procedure acquiring unit 80, and the display control unit 82) constitute an abnormality processing device 90 (FIG. 1) that provides the procedure PR for dealing with the abnormality AB. In this way, in the present embodiment, the abnormality processing device 90 is installed in the preventive maintenance device 14.

In the abnormality processing device 90, the storage 64 stores the plurality of procedures PR in association with the abnormality specifying information SI, the abnormality detecting unit 74 detects the abnormality AB based on the operation condition data OD, and the data acquiring unit 78 acquires the abnormality specifying information SI (specifically, the abnormality identification code SI1) of the abnormality AB detected by the abnormality detecting unit 74, and the procedure PR corresponding to the abnormality specifying information SI acquired by the data acquiring unit 78 is acquired from among the plurality of procedures PR stored in the storage 64. According to this configuration, it is possible to automatically acquire and provide the procedures PR for dealing with the various abnormalities AB that may occur in the robot system 12. Thus, it is possible to appropriately and easily deal with the various abnormalities AB.

In the abnormality processing device 90, the input receiving unit 76 receives an input of the procedure PR and the abnormality specifying information SI (abnormality identification code SI1), and the storage 64 stores the procedure PR and the abnormality specifying information SI received by the input receiving unit 76 in association with each other. According to this configuration, since the operator A2 can freely input the procedure PR and the abnormality specifying information SI, it is possible to update the procedure PR and the abnormality specifying information SI to the latest data by adding, deleting, or editing the procedure PR and the abnormality specifying information SI as necessary.

In the abnormality processing device 90, the abnormality specifying information SI includes the abnormality identification codes SI1 individually assigned to the plurality of types of abnormalities AB, and the data acquiring unit 78 acquires the abnormality identification code SI1 assigned to the abnormality AB detected by the abnormality detecting unit 74 as the abnormality specifying information SI. According to this configuration, the processor 62 functions as the procedure acquiring unit 80 to be able to easily and quickly search for the procedure PR for dealing with the abnormality AB based on the abnormality identification code SI1.

In the abnormality processing device 90, the display control unit 82 causes the display devices 50 and 70 to display, as an image, the procedure PR acquired by the procedure acquiring unit 80. By visually recognizing the image of the procedure PR displayed on the display devices 50 and 70 in this way, the operator A1 of the work line and the operator A2 of the preventive maintenance device 14 can easily understand the procedure PR for dealing with the abnormality AB. The operator A1 can then appropriately deal with the abnormality AB at the work line according to the procedure PR displayed on the display device 50 even without expert knowledge.

Note that the processor 62 may function as the display control unit 82 to transmit the image data of the procedure PR acquired by the procedure acquiring unit 80 to the external device 16 via the communication network 18 and cause a display device (not illustrated) provided at the external device 16 to display the image data. In this case, an operator A3 of the external device 16 (e.g., a manager of the work line) can also easily understand the procedure PR for dealing with the abnormality AB.

Note that the procedure PR may include sound data for describing the procedure PR with sound, instead of (or in addition to) the image data. In this case, the processor 62 may output the sound data of the procedure PR from a speaker provided at the preventive maintenance device 14 (or the controller 24). When the procedure PR includes only sound data, the display control unit can be omitted from the abnormality processing device 90.

The input receiving unit 76 can be omitted from the abnormality processing device 90. For example, the procedure PR and the abnormality specifying information SI may be prepared using the external device 16 of the abnormality processing device 90 and downloaded to the preventive maintenance device 14 via the communication network 18 (or an external memory).

Note that the operator A1 needs to disconnect the robot 20 from the work line according to the type of the abnormality AB. For example, the abnormality AB2 indicating voltage drop of the battery can be dealt with at the work line by the operator A1 replacing the battery. In contrast, the abnormality AB3 indicating malfunction of the force sensor 22F cannot be dealt with at the work line by the operator A1 because the operator A1 cannot replace the force sensor 22F.

In such a case, in order to continue the work at the work line, it is necessary to disconnect the robot 20 provided with the force sensor 22F from the work line. Thus, a procedure PR3 for dealing with the abnormality AB3 indicating malfunction of the force sensor 22F includes, for example, a procedure PR3_{_1} for disconnecting the robot 20 from the work line and a procedure PR3_{_1} for causing the operator A1 to manually perform the work that has been performed by the robot 20 at the work line.

Specifically, the procedure PR3_{_1} for disconnecting the robot 20 can include image data of text for describing, with words, a procedure for operating the guided vehicle 26 to remove the robot 20 from the work line, or still or moving image data representing an operation in which the operator A1 performs this procedure. The procedure PR3_{_1} for disconnecting the robot 20 can include image data of text for describing, with words, a procedure for cutting communication connection between the controller 24 and a host controller (not illustrated) of the controller 24, or still or moving image data representing an operation in which the operator A1 performs this procedure.

On the other hand, the procedure PR3_{_1} for causing the operator A1 to perform the work in place of the robot 20 can include image data of text for describing, with words, a procedure (e.g., a procedure for workpiece handling) for the work to be performed by the operator A1 in place of the robot 20 at the work line after the disconnection of the robot 20, or still or moving image data representing an operation in which the operator A1 performs this procedure.

When detecting the abnormality AB3 indicating malfunction of the force sensor 22F, the processor 62 functions as the data acquiring unit 78 to acquire the abnormality identification code SI1 of “AB003” assigned to the abnormality AB3 and functions as the procedure acquiring unit 80 to search for and acquire the procedure PR3 associated with the abnormality identification code SI1 of “AB003” from the storage 64. The processor 62 then functions as the display control unit 82 to supply the image data of the procedure PR3 to the display devices 50 and 70 and causes the display devices 50 and 70 to sequentially display the image of the procedure PR3_{_1} and the image of the procedure PR3_{_1}.

According to this configuration, in order to deal with the abnormality AB3, the operators A1 and A2 can easily understand the procedure PR3_{_1} for disconnecting the robot 20 from the work line and the procedure PR3_{_1} for the work to be performed by the operator A1 in place of the robot 20 after the disconnection. As a result, the operator A1 performs the work of the robot 20 in place of the robot 20, thereby enabling the work at the work line to continue.

Note that the abnormality AB requiring the procedure PR3 for disconnecting the robot 20 and performing the work in place of the robot 20 may include an abnormality other than the abnormality AB3 indicating malfunction of the force sensor 22F. For example, in the case of an abnormality AB5′ in which the abnormality AB5 indicating imaging failure of the vision sensor 22G repeatedly occurs and the abnormality AB6 indicating a detection value of the sensor 22 (e.g., the detection value is continuously zero), it may be necessary to provide the procedure PR3. The procedure PR3 is stored in the storage 64 in association with the abnormality identification codes SI1 (e.g., “AB003”, “AB005”, and “AB006”) assigned to these abnormalities AB3, AB5′, AB6, and the like.

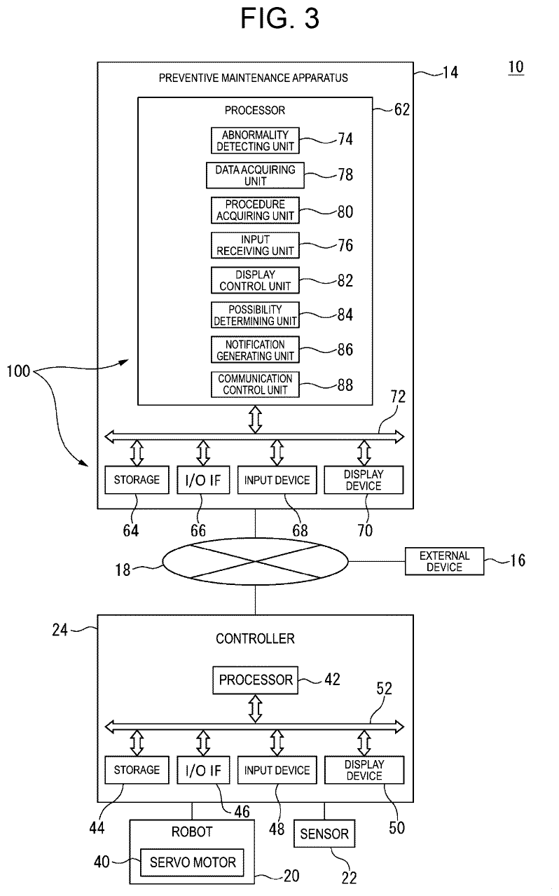

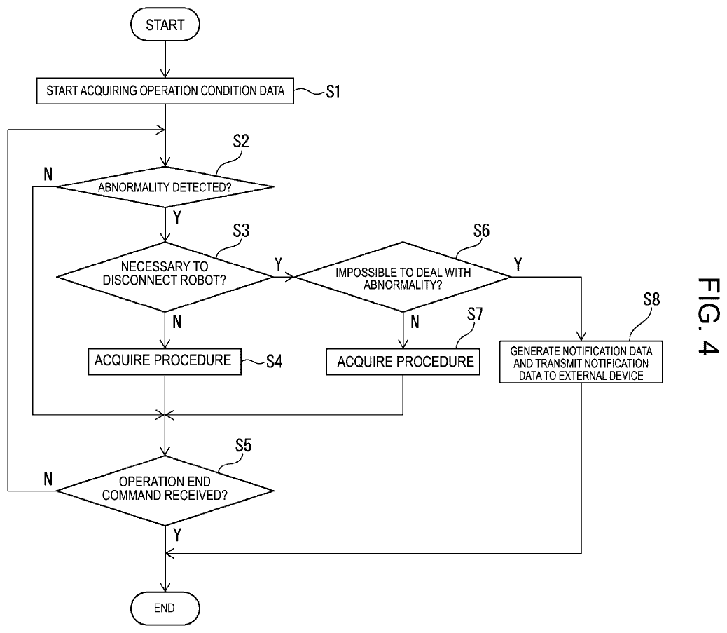

Next, other functions of the preventive maintenance device 14 will be described with reference to FIG. 3. In the present embodiment, the processor 62 functions as a possibility determining unit 84, a notification generating unit 86, and a communication control unit 88, in addition to the abnormality detecting unit 74, the input receiving unit 76, the data acquiring unit 78, the procedure acquiring unit 80, and the display control unit 82 described above. Next, operation processing of the preventive maintenance device 14 will be described with reference to FIG. 4. The processing illustrated in FIG. 4 starts when the processor 62 receives an operation start command from the operator A2, the host controller, or the computer program.

In step S1, the processor 62 starts an operation of acquiring the operation condition data OD. Specifically, as described above, the processor 62 starts an operation of continuously (e.g., periodically) acquiring the operation condition data OD from the controller 24 through the communication network 18.

In step S2, the processor 62 functions as the abnormality detecting unit 74 to determine whether or not the abnormality AB has been detected based on the operation condition data OD by the above-described method. If the abnormality AB has been detected, the processor 62 determines YES and proceeds to step S3. On the other hand, if the abnormality AB has not been detected, the processor 62 determines NO and proceeds to step S5.

In step S3, the processor 62 determines whether or not the robot 20 needs to be disconnected from the work line based on the abnormality specifying information SI. Specifically, the processor 62 functions as the data acquiring unit 78 to acquire, as the abnormality specifying information SI, the abnormality identification code SI1 of the abnormality AB detected in most recent step S2.

The processor 62 then determines whether or not the acquired abnormality identification code SI1 corresponds to a code SI1x for requiring the robot 20 to be disconnected from the work line. For example, the abnormality identification codes SI1 of “AB003”, “AB005”, and “AB006” assigned to the above-described abnormalities AB3, AB5′, and AB6 are classified into the code SIIx.

In step S3, if the abnormality identification code SI1 (e.g., “AB003”, “AB005”, or “AB006”) classified into the code SI1_{X} has been acquired, the processor 62 determines YES and proceeds to step S6. On the other hand, if the abnormality identification code SI1 not classified into the code SI1_{X} has been acquired, the processor 62 determines NO and proceeds to step S4.

In step S4, the processor 62 functions as the procedure acquiring unit 80 to acquire, by the above-described method, the procedure PR corresponding to the abnormality specifying information SI (specifically, the abnormality identification code SI1) acquired in most recent step S3 from among the plurality of procedures PR stored in the storage 64. The processor 62 then functions as the display control unit 82 to cause the display devices 50 and 70 (and the display device of the external device 16) to display the acquired procedure PR as an image.

In step S5, the processor 62 determines whether or not an operation end command has been received from the operator A2, the host controller, or the computer program. If the operation end command has been received, the processor 62 determines YES and ends the processing illustrated in FIG. 4. On the other hand, if the operation end command has not been received, the processor 62 determines NO and returns to step S2.

On the other hand, if YES has been determined in step S3, the processor 62 determines in step S6 whether or not the abnormality AB detected in most recent step S2 can be dealt with. Here, there are cases where the operator A1 cannot disconnect the robot 20 from the work line (e.g., a case where the operator A1 is not permitted to operate the guided vehicle 26, or a case where, in the first place, the robot 20 does not include the guided vehicle 26, is fixed to the work line and cannot move).

There is also a case where the operator A1 cannot perform the work that has been performed by the robot 20 in place of the robot 20 (e.g., a case where the robot 20 has performed laser machining). In these cases, the operator A1 cannot deal with the detected abnormality AB at the work line.

Thus, in step S6, the processor 62 acquires, together with the abnormality specifying information SI, possibility determination information DI for determining whether or not the abnormality AB can be dealt with and determines whether or not the abnormality AB can be dealt with based on the possibility determination information DI. As an example, the possibility determination information DI includes an identification code DI1 (a manufacturer's serial number, a model number, or the like) for identifying the robot 20, and a data table DT2 storing an identification code DI1_{X} of a robot that cannot be disconnected from the work line.

As another example, the possibility determination information DI includes an identification code DI2 (e.g., an identification code representing laser machining) for identifying the work performed by the robot 20 and a data table DT3 storing an identification code DI2_{X} of work that the operator A1 cannot perform in place of the robot 20. The identification codes DI1 and DI2 and the data tables DT2 and DT3 are stored in advance in, for example, the storage 44 of the controller 24.

The processor 62 functions as the data acquiring unit 78 to acquire the abnormality specifying information SI (abnormality identification code SI1) of the abnormality AB detected in most recent step S2 and also acquire the identification code DI1 (or DI2) and the data table DT2 (or DT3) from the controller 24 via the communication network 18.

The processor 62 then determines whether or not the acquired identification code DI1 (or DI2) corresponds to the identification code DI1_{X} (or DI2_{X}) included in the data table DT2 (or DT3), determines YES and proceeds to step S8 if the acquired identification code corresponds, and determines NO and proceeds to step S7 if the acquired identification code does not correspond. In this way, in the present embodiment, the processor 62 functions as the possibility determining unit 84 (FIG. 3) that determines whether or not the abnormality AB can be dealt with based on the possibility determination information DI.

In step S7, the processor 62 functions as the procedure acquiring unit 80 to acquire the procedure PR3 (specifically, the procedures PR3_{_1} and PR3_{_2}) for disconnecting the robot 20 and performing the work in place of the robot 20, which corresponds to the abnormality specifying information SI (e.g., the abnormality identification code SI1 of “AB003”, “AB005”, or “AB006”) acquired in most recent step S3.

The processor 62 then functions as the display control unit 82 to cause the display devices 50 and 70 (and the display device of the external device 16) to display the acquired procedure PR3 as an image. As a result, the operator A1 of the work line can easily understand the procedure PR3_{_1} for disconnecting the robot 20 from the work line and the procedure PR3_{_2} for performing the work in place of the robot 20 after the disconnection of the robot 20 and can perform these procedures PR3_{_1} and PR3_{_2} at the work line without expert knowledge.

In step S8, the processor 62 generates notification data ND for notifying that the abnormality AB detected in most recent step S2 cannot be dealt with and transmits the notification data ND to the external device 16. Specifically, the processor 62 generates, for example, notification data ND representing a warning “An abnormality that cannot be dealt with in the robot system” as image data or sound data. In this way, in the present embodiment, if it is determined in step S6 that it is impossible to deal with the abnormality AB (i.e., YES), the processor 62 functions as the notification generating unit 86 (FIG. 3) that generates the notification data ND.

The processor 62 then transmits the generated notification data ND to the external device 16 registered as a transmission destination in advance in the storage 64 via the communication network 18. Note that the processor 62 may transmit the notification data ND to the external device 16 in the form of an e-mail.

Accordingly, the operator A3 of the external device 16 (e.g., a manager of the work line) can easily recognize that the abnormality AB that cannot be dealt with in the robot system 12. In this way, in the present embodiment, the processor 62 functions as the communication control unit 88 (FIG. 3) that transmits the generated notification data ND to the external device 16. After performing step S8, the processor 62 ends the processing illustrated in FIG. 4.

As described above, in the present embodiment, the processor 42 functions as the abnormality detecting unit 74, the input receiving unit 76, the data acquiring unit 78, the procedure acquiring unit 80, the display control unit 82, the possibility determining unit 84, the notification generating unit 86, and the communication control unit 88 to provide the procedures PR stored in the storage 64.

Thus, the storage 64 and the processor 42 (the abnormality detecting unit 74, the input receiving unit 76, the data acquiring unit 78, the procedure acquiring unit 80, the display control unit 82, the possibility determining unit 84, the notification generating unit 86, and the communication control unit 88) constitute an abnormality processing device 100 (FIG. 1) that provides the procedure PR for dealing with the abnormality AB. In this way, in the present embodiment, the abnormality processing device 100 is installed in the preventive maintenance device 14.

In the abnormality processing device 100, the data acquiring unit 78 acquires the possibility determination information DI together with the abnormality specifying information SI, the possibility determining unit 84 determines whether or not the abnormality AB can be dealt with based on the possibility determination information DI, and when the possibility determining unit 84 determines that the abnormality AB cannot be dealt with, the notification generating unit 86 generates the notification data ND for providing this notification. According to this configuration, when the abnormality AB that cannot be dealt with by the operator A1 at the work line has occurred in the robot system 12, this notification can be automatically provided.

In the abnormality processing device 100, the communication control unit 88 transmits the notification data ND generated by the notification generating unit 86 to the external device 16 of the abnormality processing device 100. According to this configuration, it is possible to automatically notify the operator A3 of the external device 16 (e.g., a manager of the work line) that the abnormality AB that cannot be dealt with has occurred.

Note that in above-described step S4, the processor 62 may provide the procedure PR in a stepwise manner in response to input data IP from the operator. For example, the procedure PR5 for dealing with the abnormality AB5 indicating imaging failure of the vision sensor 22G includes a procedure PR5_{_1} for checking the installation position (or a member) of the vision sensor 22G and a procedure PR5_{_2} for performing calibration of the vision sensor 22G.

In this case, in step S4, the processor 62 first acquires the procedure PR5_{_1} and causes the display device 50 to display the procedure PR5_{_1}. At this time, the processor 62 causes the display device 50 to display an input image for inputting the presence or absence of a deviation in the installation position of the vision sensor 22G. The operator A1 checks the presence or absence of a deviation in the installation position of the vision sensor 22G according to the procedure PR5_{_1}, and when the deviation has been eliminated, operates the input device 48 to input, in the input image displayed on the display device 50, input data IP1 indicating that the abnormality AB5 has been dealt with.

On the other hand, when there is no deviation in the installation position of the vision sensor 22G, the operator A1 operates the input device 48 to input, in the input image displayed on the display device 50, input data IP2 indicating that there is no deviation. When receiving the input data IP1 from the controller 24, the processor 62 ends step S4. On the other hand, when receiving the input data IP2 from the controller 24, the processor 62 acquires the procedure PR5_{_2} for performing calibration and causes the display device 50 to display the procedure PR5_{_2}. Providing the procedure PR in a stepwise manner in step S4 in this way allows the operator A1 to take appropriate measures in response to the situation of the robot system 12.

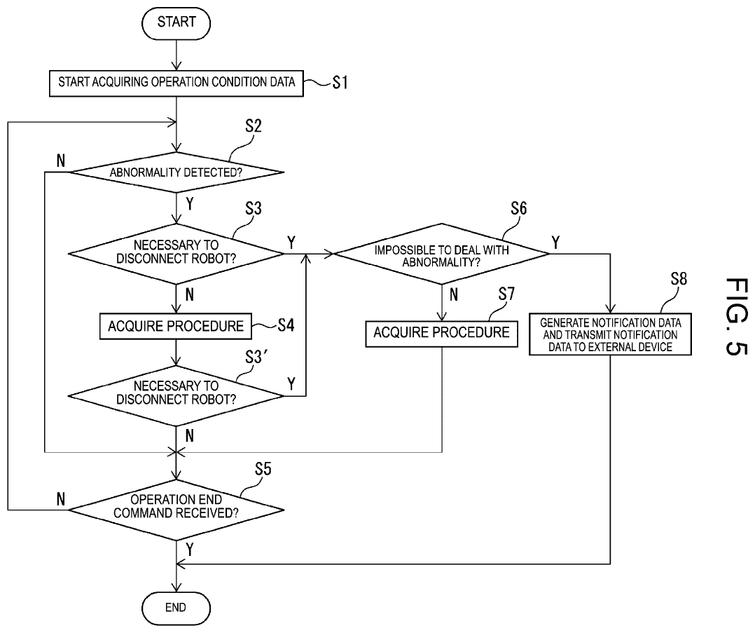

Next, other functions of the preventive maintenance device 14 illustrated in FIG. 3 will be described with reference to FIG. 5. Note that in the processing illustrated in FIG. 5, processes similar to those of the processing illustrated in FIG. 4 are assigned identical step numbers, and overlapping descriptions thereof will be omitted. After the processing illustrated in FIG. 5 starts, the processor 62 performs step S1 to step S4 as in the processing of FIG. 4.

After step S4, in step S3′, the processor 62 determines whether or not the robot 20 needs to be disconnected from the work line based on the input data IP from the operator A1. Here, even when the procedure PR for dealing with the abnormality AB is provided to the operator A1 in step S4 and the operator A1 performs the procedure PR, there are cases in which the abnormality AB cannot be dealt with.

As an example, it is assumed that, in step S2, the processor 62 detects that the external force F acquired by the force sensor 22F increases beyond the reference value β_{F2} (F>β_{E2}), thereby detecting the abnormality AB4 in which the robot 20 collides with the surrounding environmental object. In this case, the processor 62 determines NO in step S3, and in step S4, the processor 62 acquires the procedure PR4 for dealing with the abnormality AB4 (i.e., image data for describing a procedure for checking the presence or absence of a collision) and causes the display device 50 of the controller 24 to display the procedure PR4.

At the same time, the processor 62 supplies the controller 24 with an input image for inputting the presence or absence of a collision between the robot 20 and the surrounding environmental object and causes the display device 50 to display the input image. An operator A checks the presence or absence of a collision between the robot 20 and the surrounding environmental object according to the procedure PR4, and when there is such a collision, the operator A takes a measure of resolving the collision, such as removing the surrounding environmental object. This makes it possible to deal with the abnormality AB4. In this case, the operator A operates the input device 48 to input, in the input image displayed on the display device 50, input data IP1 indicating that there has been a collision with the surrounding environmental object.

On the other hand, when the operator A checks the presence or absence of a collision between the robot 20 and the surrounding environmental object according to the procedure PR4 and, as a result, there is no such collision, the abnormality in which the external force F increases beyond the reference value Br2 can be caused by the abnormality AB3 indicating malfunction of the force sensor 22F, which cannot be dealt with by the operator A. In this case, the operator A operates the input device 48 to input, in the input image displayed on the display device 50, input data IP2 indicating that there has been no collision with the surrounding environmental object.

As another example, it is assumed that the processor 62 detects the abnormality AB5 indicating imaging failure of the vision sensor 22G in step S2. In this case, the processor 62 determines NO in step S3 and, in step S4, the processor 62 acquires the procedure PR5 for dealing with the abnormality AB5 (i.e., image data for describing a procedure for checking the vision sensor 22G and performing calibration) and causes the display device 50 of the controller 24 to display the procedure PR5.

At the same time, the processor 62 supplies the controller 24 with an input image for inputting whether or not the abnormality AB5 is eliminated and causes the display device 50 to display the input image. The operator A takes necessary measures such as calibration according to the procedure PR5. As a result, when the abnormality AB5 is eliminated, the operator A operates the input device 48 to input, in the input image displayed on the display device 50, input data IP1 indicating that the abnormality AB5 is eliminated.

On the other hand, when the operator A1 takes measures according to the procedure PR5, but cannot eliminate the abnormality AB5, it is determined that the abnormality AB5′ that cannot be dealt with by the operator A has occurred. In this case, the operator A1 operates the input device 48 to input, in the input image displayed on the display device 50, input data IP2 indicating that the abnormality AB5 is not eliminated. The processor 42 of the controller 24 transmits the input data IP1 or IP2 input by the operator A1 as described above to the preventive maintenance device 14 via the communication network 18.

In step S3′, if the input data IP2 has been received from the controller 24, the processor 62 determines that the robot 20 needs to be disconnected (i.e., YES) and proceeds to step S6. On the other hand, if the input data IP1 has been received from the preventive maintenance device 14, the processor 62 determines that the robot 20 does not need to be disconnected (i.e., NO) and proceeds to step S5. The processor 62 then sequentially performs steps S6 to S8 or step S5 as in the processing of FIG. 4.

As described above, in the present embodiment, the processor 62 determines whether or not the robot 20 needs to be disconnected based on the abnormality specifying information SI in step S3, provides the procedure PR in step S4, and then determines again whether or not the robot 20 needs to be disconnected based on the input data IP from the operator A1 in step S3′. According to this configuration, even when the abnormality AB cannot be dealt with according to the procedure PR presented in step S4, the work can continue by disconnecting the robot 20 in step S7. Thus, it is possible to reduce the possibility that the work is interrupted.

Note that in the embodiments described above, cases have been described where the abnormality processing devices 90 and 100 are installed in the preventive maintenance device 14. However, the present invention is not limited thereto, and at least one of the components of the abnormality processing device 90 or 100 (i.e., the storage 64, the abnormality detecting unit 74, the input receiving unit 76, the data acquiring unit 78, the procedure acquiring unit 80, the display control unit 82, the possibility determining unit 84, the notification generating unit 86, and the communication control unit 88) may be installed in the controller 24.

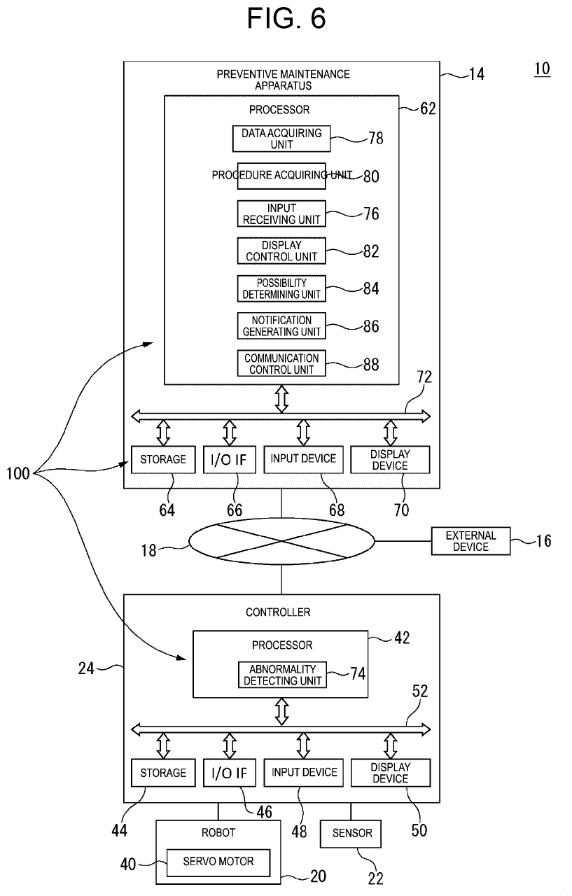

Such a mode is illustrated in FIG. 6. In the network system 10 illustrated in FIG. 6, the storage 64, the input receiving unit 76, the data acquiring unit 78, the procedure acquiring unit 80, the display control unit 82, the possibility determining unit 84, the notification generating unit 86, and the communication control unit 88 of the abnormality processing device 100 are installed in the preventive maintenance device 14, while the abnormality detecting unit 74 of the abnormality processing device 100 is installed in the controller 24.

In the network system 10 illustrated in FIG. 6, the processor 42 of the controller 24 and the processor 62 of the preventive maintenance device 14 perform the processing illustrated in FIG. 4 or 5 while communicating with each other. Specifically, the processor 42 of the controller 24 starts an operation of acquiring the operation condition data OD from the sensor 22 in step S1, and in step S2, functions as the abnormality detecting unit 74 to determine whether or not the abnormality AB has been detected based on the operation condition data OD as in the embodiments described above.

When detecting the abnormality AB in step S2 (i.e., the determination is YES), the processor 42 of the controller 24 provides the abnormality specifying information SI (specifically, the abnormality identification code SI1) of the detected abnormality AB to the preventive maintenance device 14 via the communication network 18. The processor 62 of the preventive maintenance device 14 functions as the data acquiring unit 78 to acquire the abnormality specifying information SI from the controller 24 and sequentially perform steps S3 to S8 as in the above-described embodiments.

Note that the abnormality processing device 90 or 100 may be installed in the controller 24. In this case, the storage 44 of the controller 24 stores the plurality of procedures PR in association with the abnormality specifying information SI, and the processor 42 of the controller 24 functions as the abnormality detecting unit 74, the input receiving unit 76, the data acquiring unit 78, the procedure acquiring unit 80, the display control unit 82, the possibility determining unit 84, the notification generating unit 86, and the communication control unit 88.

Note that the abnormality specifying information SI is not limited to the abnormality identification codes SI1 and may include any other data for specifying the abnormality AB. For example, the abnormality specifying information SI may include data identification codes SI2 individually assigned to the plurality of types of operation condition data OD detected by the sensor 22 (e.g., the rotational position Pm, the rotation speed Vm, the rotation acceleration am, the current value I, the load torque t, the position Pc, the speed Vc, the acceleration ac, the pressure P, the voltage E, the external force F, the image data ID, etc.).

The storage 64 (or 44) stores the plurality of procedures PR in association with the data identification codes SI2. For example, the data identification code SI2 of “DATA-E” can be assigned to the voltage E detected by the voltage sensor 22E, and the procedure PR2 related to the abnormality AB2 of the voltage E (image data for describing a procedure for replacing the battery) can be stored in the storage 64 in association with the data identification code SI2 of “DATA-E”.

The plurality of data identification codes SI2 may be assigned to one type of operation condition data OD in response to the aspect of change thereof. For example, regarding the external force F detected by the force sensor 22F, the data identification code SI2 of “DATA-F1” may be assigned to the external force F1 decreasing below the reference value β_{F1}, while the data identification code SI2 of “DATA-F2” may be assigned to the external force F2 increasing above the reference value β_{F2}.

In this case, the procedure PR3 related to the abnormality AB3 indicating the external force decrease (image data for describing disconnection of the robot 20 and work to be performed in place of the robot 20) can be stored in the storage 64 in association with the data identification code SI2 of “DATA-F1”. The procedure PR4 related to the abnormality AB4 indicating the external force increase (image data for describing a procedure for checking the presence or absence of a collision) can be stored in the storage 64 in association with the data identification code SI2 of “DATA-F2”.

The processor 62 (or 42) functions as the data acquiring unit 78 to acquire, as the abnormality specifying information SI, the data identification code SI2 instead of (or in addition to) the abnormality identification code SI1 described above. For example, when detecting the abnormality AB2 in which the voltage E decreases, the processor 62 (or 42) functions as the data acquiring unit 78 to acquire, as the abnormality specifying information SI, the data identification code SI2 of “DATA-E” assigned to the voltage E.

The abnormality specifying information SI may include sensor identification codes SI3 individually assigned to the plurality of types of sensors 22 (e.g., the rotation detecting sensor 22A, the current sensor 22B, the torque sensor 22C, the pressure sensor 22D, the voltage sensor 22E, the force sensor 22F, and the vision sensor 22G). The storage 64 (or 44) stores the plurality of procedures PR in association with the sensor identification codes SI3.

For example, the sensor identification code SI3 of “SENSOR-E” is assigned to the voltage sensor 22E, and the procedure PR2 related to the abnormality AB2 of the voltage E detected by the voltage sensor 22E can be stored in the storage 64 in association with the sensor identification code SI3 of “SENSOR-E”.

The processor 62 (or 42) functions as the data acquiring unit 78 to acquire, as the abnormality specifying information SI, the sensor identification code SI3 instead of (or in addition to) the above-described abnormality identification code SI1. For example, when detecting the abnormality AB2 in which the voltage E decreases, the processor 62 (or 42) functions as the data acquiring unit 78 to acquire, as the abnormality specifying information SI, the sensor identification code SI3 of “SENSOR-E” assigned to the voltage sensor 22E detecting the voltage E. Note that the abnormality identification code SI1, the data identification code SI2, and the sensor identification code SI3 are not limited to character strings, but may be combinations of symbols (∘, Δ, □, +, −, *, etc.), for example. The procedure PR may also include multilingual text data.

There may be various abnormalities AB and procedures PR other than those described as examples in the above embodiment. For example, the abnormalities AB can include an abnormality AB6 indicating communication failure between the sensor 22 or the servo motor 40 and the controller 24 (I/O interface 46). The abnormality AB6 can be detected by monitoring a detection value of the sensor 22 or the servo motor 40, for example. A procedure PR6 for dealing with the abnormality AB6 includes, for example, image data or sound data for describing a procedure for checking connection of a communication cable between the sensor 22 or the servo motor 40 and the controller 24.

Note that the robot 20 is not limited to the vertical articulated robot illustrated in FIG. 2, and may be any other type of robot, such as a horizontal articulated robot, a parallel link robot, or a work table device including a plurality of ball screw mechanisms. The present disclosure has been described through the embodiments above, but the above embodiments do not limit the invention claimed in the present patent.

### REFERENCE SIGNS LIST

10 Network system
12 Robot system
14 Preventive maintenance device
16 External device
18 Communication network
20 Robot
22 Sensor
24 Controller
42, 62 Processor
74 Abnormality detecting unit
76 Input receiving unit
78 Data acquiring unit
80 Procedure acquiring unit
82 Display control unit
84 Possibility determining unit
86 Notification generating unit
88 Communication control unit

1. An abnormality processing device configured to provide a procedure for dealing with an abnormality which occurs in a robot system, the abnormality processing device comprising:
a storage configured to store a plurality of the procedures for dealing with a plurality of types of the abnormalities respectively, in association with abnormality specifying information for specifying the abnormalities;
an abnormality detecting unit configured to detect the abnormality, based on operation condition data of the robot system;
a data acquiring unit configured to acquire the abnormality specifying information on the abnormality detected by the abnormality detecting unit; and
a procedure acquiring unit configured to acquire the procedure corresponding to the abnormality specifying information acquired by the data acquiring unit, from the plurality of procedures stored in the storage.

2. The abnormality processing device according to claim 1, further comprising an input receiving unit configured to receive an input of the procedure and the abnormality specifying information,
wherein the storage is configured to store the procedure and the abnormality specifying information received by the input receiving unit in association with each other.

3. The abnormality processing device according to claim 1, wherein the abnormality specifying information includes abnormality identification codes individually assigned to the plurality of types of the abnormalities, and
wherein the data acquiring unit is configured to acquire, as the abnormality specifying information, the abnormality identification code assigned to the abnormality detected by the abnormality detecting unit.

4. The abnormality processing device according to claim 1, further comprising a display control unit configured to cause a display device to display the procedure acquired by the procedure acquiring unit, as an image.

5. The abnormality processing device according to claim 1, wherein the data acquiring unit is configured to acquire possibility determination information for determining whether or not the abnormality can be dealt with, together with the abnormality specifying information, and
wherein the abnormality processing device includes:
a possibility determining unit configured to determine whether or not the abnormality detected by the abnormality detecting unit can be dealt with, based on the possibility determination information; and
a notification generating unit configured to generate notification data for notifying that it is impossible to deal with the abnormality when the possibility determining unit determines that the abnormality cannot be dealt with.

6. The abnormality processing device according to claim 5, further comprising a communication control unit configured to transmit the notification data generated by the notification generating unit to an external device of the abnormality processing device.

7. A network system comprising:
a robot system including a robot and a controller configured to control the robot; and
the abnormality processing device according to claim 1.

8. The network system according to claim 7, comprising a preventive maintenance device communicably connected to the controller via a communication network, and configured to acquire the operation condition data from the controller,
wherein the abnormality processing device is installed in the preventive maintenance device.

9. The network system according to claim 7, further comprising a preventive maintenance device communicably connected to the controller via a communication network, and configured to acquire the operation condition data from the controller,
wherein the storage, the data acquiring unit, and the procedure acquiring unit of the abnormality processing device are installed in the preventive maintenance device, while the abnormality detecting unit of the abnormality processing device is installed in the controller, and
wherein the controller provides the abnormality specifying information of the abnormality detected by the abnormality detecting unit to the preventive maintenance device via the communication network.

10. A method of providing a procedure for an abnormality which occurs in a robot system, the method comprising:
storing, in a storage, a plurality of the procedures for dealing with a plurality of types of the abnormalities respectively, in association with abnormality specifying information for specifying the abnormalities;
detecting the abnormality based on operation condition data of the robot system;
acquiring the abnormality specifying information on the detected abnormality; and
acquiring the procedure corresponding to the acquired abnormality specifying information, from the plurality of procedures stored in the storage.
